(19) United States
(12) Patent Application Publication
(10) Pub. No.: US 2026/0242183 A1
(43) Pub. Date: Aug. 20, 2026

(54) DEVICE FOR REMOVING FLUIDS AND DIRT

(71) Applicant: Inventio AG, Hergiswil (CH)

(72) Inventor: Georg Wagenleitner, Roßleithen (AT)

(21) Appl. No.: 19/144,876

(22) PCT Filed: Jan. 25, 2024
(86) PCT No.: PCT/EP2024/051697

§ 371 Date: Jun. 30, 2025

(30) Foreign Application Priority Data
Feb. 1, 2023 (EP) 23154413.1

(51) Int. Cl. B66B 31/02

(52) U.S. Cl. CPC B66B 31/02

(57) ABSTRACT

The present disclosure relates to a device for removing fluids and dirt from a moving handrail of an escalator or a moving walkway. The device comprises a holder and a scraper body having a scraper lip, wherein the scraper lip has a wedge-shaped cross-section. In addition, adjacent to the scraper lip, a collecting channel is formed in the scraper body.

### TECHNICAL FIELD

The present disclosure relates to a device for removing fluids and dirt from a moving handrail of an escalator or moving walkway.

### SUMMARY

Escalators and moving walkways are used to transport people and carried objects in buildings such as train stations, subway stations, airports, shopping centers, department stores, and the like. For transportation purposes, escalators and moving walkways have a revolving conveyor belt that can be walked on. To ensure that people can protect themselves against falls while traveling, escalators and moving walkways have balustrades on both sides of the conveyor belt, on each of which a handrail is arranged in a revolving manner. The two handrails must be driven at a synchronous speed to the conveyor belt in accordance with relevant standards, such as EN115. Handrails usually have a C-shaped cross-section. The leading run thereof is guided by means of a T-shaped guide profile rigidly attached to the balustrade, in that the guide profile is arranged in the inner cross-section of the handrail. The return of the return run takes place in a manner hidden from the people, within a balustrade base of the balustrade.

As disclosed in EP 2 931 645 B1, for example, a handrail is driven by means of a handrail drive wheel which is arranged inside the escalator or moving walkway. Said handrail drive wheel transmits its drive torque and drive movement to an inner side of the C-shaped handrail by means of frictional engagement. As long as the escalator or moving walkway is installed indoors in a manner protected from the effects of weather, there are hardly any problems in terms of the traction between the handrail and the handrail drive wheel. In the case of escalators and moving walkways that are used entirely or partially outdoors, a relatively large amount of fluid, in particular water, may also accumulate on the inner side of the C-shaped handrail in rainy weather and may significantly change the friction conditions between the handrail drive wheel and the handrail. This may result in slip-stick effects, leading to an uneven movement of the handrail, which is unpleasant for the user. In addition, most regulations, such as the EN115 standard, prohibit a handrail speed that is slower than the conveyor belt speed.

To solve this problem, JP H0439288 A discloses a displacement body in the form of a wedge plow, which pushes aside the water drops on the surface of the handrail. However, if there are large amounts of water on the inside of the handrail, this solution is ineffective, as the water pushed aside immediately flows back onto the surface after the displacement body.

The object of the present disclosure is therefore to provide reliable prevention of the ingress of large amounts of fluid between the handrail drive wheel and the surface of the handrail that is in contact with the handrail drive wheel.

This object may achieved by a device for removing fluids and dirt from moving handrails of an escalator or moving walkway. The device may comprise a holder and a scraper body with a scraper lip. The scraper lip may have a wedge-shaped cross-section. The scraper body can be made of one or more polymer materials, composite materials, or metal. The scraper lip can be formed integrally on the scraper body. Of course, the scraper lip can also be manufactured as a separate component and attached to the scraper body. If the scraper lip is to be made of a more resilient and softer material than the scraper body, it can be manufactured, for example, as a multi-component plastic injection-molded part.

According to the disclosure, adjacent to the scraper lip, a collecting channel may be formed in the scraper body. As a result, the fluid scraped off by the scraper lip may be collected and channeled in the collecting channel so that it no longer flows back onto the handrail surface.

In one embodiment, the collecting channel may open into a drain line of the device in order to be able to continuously drain the fluid collected therein from the region of the device. Dirt or dirt particles scraped off the handrail surface by the scraper lip may be mostly washed into the drain pipe by the fluid. If necessary, the scraper lip and the collecting channel may be cleaned periodically by maintenance personnel.

In an alternative embodiment, the collecting channel may open into a connection piece formed in the scraper body. The connection piece may be designed to be connected to a drain pipe. Because this embodiment may allow the drain line to be separated from the device, the device may be easier to install and maintain, and the drain line may be easier to replace if it becomes clogged.

In a further embodiment of the device, it may have at least one guide roller which is rotatably mounted on the scraper body. Depending upon the arrangement of the at least one guide roller, when the device is ready for use, said roller may be in touching contact with an outer surface of the handrail or with a surface of the inner cross-section of the handrail.

In a development of the device, the at least one guide roller may be arranged on the scraper body in such a way that the guide roller's rolling surface partially protrudes from the scraper body. The projection of the rolling surface relative to the scraper body may be less than two millimeters, preferably 1.5 mm to 0.1 mm, particularly preferably 0.7 mm to 0.5 mm. The guide roller may serve to position and guide the scraper body in the inner cross-section of the handrail and thus to keep the scraper lip constantly at a very small lip distance relative to the surface of the inner cross-section. Due to this lip distance, on the one hand, the wear on the scraper lip may be minimized, and on the other, it may be ensured that almost all fluid is wiped off the surface present in the inner cross-section. In this case, the lip distance can be 0.0 mm to 0.1 mm, preferably 0.001 mm to 0.05 mm.

In a further embodiment of the device, a first guide roller may protrude from a bottom surface of the scraper body, a second guide roller may protrude from a left-hand side surface of the scraper body, and a third guide roller may protrude from a right-hand side surface of the scraper body. The axes of rotation of the second and third guide rollers may be arranged parallel to each other and orthogonal to the axis of rotation of the first guide roller in the scraper body. This embodiment may allow the scraper body to be guided precisely and with little wear on all inner sides of the handrail's inner cross-section.

The holder of the device may have a first holder part which may be designed such that it can be fixedly attached to a stationary component of an escalator or a moving walkway. The stationary component can, for example, be a supporting structure of the escalator or moving walkway. Furthermore, the holder may comprise a second holder part which may be fixedly connected to the first holder part in a plane in a path-limited, floating manner and orthogonally to this plane. This plane may be selected so that, when the device is installed in the escalator, it may extend orthogonally to the longitudinal extension and thus to the direction of movement of the handrail. The scraper body may be attached to the second holder part. The term “path-limited, floating” in the present document means that the second holder part can move in this plane and within fixed limits, without significant resistance, relative to the first support part. Orthogonal to this plane, minimal movements may be possible, which may be predetermined by a required guide clearance between the first and second holder parts. This floating connection may allow the forces on the scraper lip or the guide rollers described above to be minimized and thus their wear to be drastically reduced.

The device can be used in any escalator or moving walkway that has at least one peripherally arranged, moving handrail with a C-shaped cross-section, and a handrail drive with a handrail drive wheel. Usually, the handrail drive wheel may be arranged in the region of a return run of the handrail, wherein the handrail can be driven by the handrail drive wheel. The escalator or moving walkway may preferably have, for each of its handrails, at least one device for removing fluids and dirt. The device may be arranged in an inner cross-section of the handrail provided by the C-shaped cross-section and directly in front of the handrail drive wheel in such a way that the device's scraper lip may be directed opposite to an intended direction of movement of the handrail. Due to a relative movement of the surface to the scraper body, fluid and dirt adhering to the handrail may be scraped off the surface of the handrail by the scraper lip.

In one embodiment, the contour of the scraper lip may be adapted to the inner cross-section of the moving handrail. Depending upon the product specification, the handrails can have different inner cross-sections. If a device according to the disclosure for removing fluids and dirt is to be used on an escalator or a moving walkway, a correspondingly adapted scraper body may be provided for the inner cross-section or the inner contour of the handrail.

If the moving walkway or escalator is to be operated in two directions, one device of the aforementioned type may be arranged on each side of the handrail drive wheel. In this case, the two devices may be arranged in such a way that in each case one scraper lip may be directed in the opposite direction for each of the two directions of movement.

The device for removing fluids and dirt, installed in an escalator or moving walkway, may preferably be arranged so that the scraper lip of the scraper body may be in scraping touching contact with the same surface of the handrail as the motion-transmitting handrail drive wheel. This may ensure optimal traction between the handrail drive wheel and the handrail.

The fluid scraped off by the device can be suctioned off the scraper lip using a pump, for example. Preferably, however, the device may be operated without additional equipment. In order to achieve this, the scraper body of the device may be arranged in an inclined portion of the handrail with respect to the direction of gravity in such a way that, as a result of gravity, the fluid scraped from the handrail by the scraper lip may pass from the scraper lip into a collecting channel formed in the scraper body. The collecting channel may also have a gravity-oriented inclination, such that the fluid may flow into a drain line adjoining the collecting channel. The fluid may be drained through the drain line into a collecting container, which can be emptied periodically.

During installation, the holder of the device may be fixed in place in the balustrade base or supporting structure of the escalator or moving walkway. This can be done using common fastening devices such as screws or rivets. The holder can, however, also be glued, soldered, or welded to stationary components of the escalator or moving walkway.

The removal of fluid and dirt may be sufficient if the scraper lip is intact. The escalator or moving walkway may have a monitoring sensor directed towards the scraper lip for monitoring the physical condition of the scraper lip. This can, for example, be a camera, a TOF camera, a laser scanner, a LiDAR sensor, and the like.

The measurement data from the monitoring sensor may be transmitted continuously or periodically to a controller of the escalator or moving walkway. These measurement data can be processed in the controller, wherein condition criteria may be stored in the controller, against which the prepared and processed measurement data may be compared. The processing of measurement data to achieve data that can be compared against condition criteria has been known for years, which is why it is not explained in detail in the present specification. Travel stop commands and/or maintenance requests and/or warning messages can be output, depending upon the result of a comparison of the measurement data against the condition criteria.

### BRIEF DESCRIPTION OF THE DRAWINGS

Preferred embodiments of the disclosure are explained in greater detail in the following description with reference to the accompanying drawings; identical elements are provided with the same reference signs in all figures. Neither the drawings nor the description are to be interpreted as limiting the disclosure. In the drawings:

FIG. 1 shows, schematically, in a sectional side view, an escalator having a revolving handrail and having a device for removing fluids and dirt from this handrail;

FIG. 2 is an enlarged, sectional side view of the region marked “A” in FIG. 1 with the device according to the disclosure;

FIG. 3 is a plan view, indicated by “B” in FIG. 2, of the device shown in FIG. 2 and the handrail; and

FIG. 4 is a section, indicated by “C-C” in FIG. 2, through the device shown in FIG. 2 and the handrail.

### DETAILED DESCRIPTION

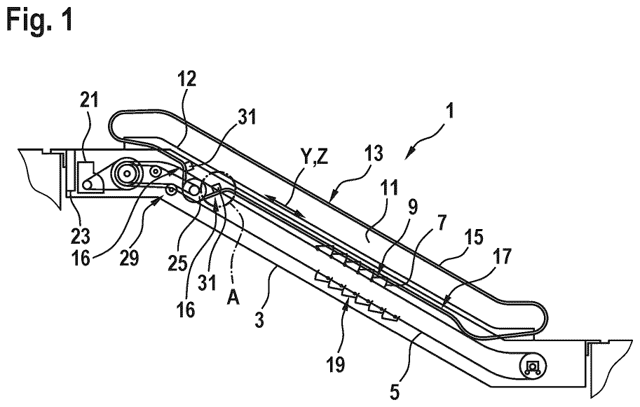

FIG. 1 shows, schematically, in a sectional side view, an escalator 1 having a supporting structure 3, in which a conveyor belt 5 with steps 7 (shown in part) is arranged in a revolving manner. Furthermore, on each side of the conveyor belt 5, a balustrade 11 is arranged on the supporting structure 3 with a balustrade base 12 (just one balustrade 11 is visible on account of the sectional side view). A handrail 15 is arranged in a revolving manner on each of these balustrades 11, wherein the forward run 13 of the handrail is intended to move in the same direction and at the same speed as the walkable run 9 of the conveyor belt 5. The return runs 17 of the handrails 15 and the return run 19 of the conveyor belt 5 are guided inside the supporting structure 3, so that they are hidden from the users. A drive unit 21 and a controller 23 are also arranged in the supporting structure 3. Also accommodated in the supporting structure 3 is a handrail drive 29, which has a handrail drive wheel 25 for each handrail 15. The drive unit 21 is connected to the conveyor belt 5 and to the respective handrail drive wheel 25 in such a way as to transmit motion.

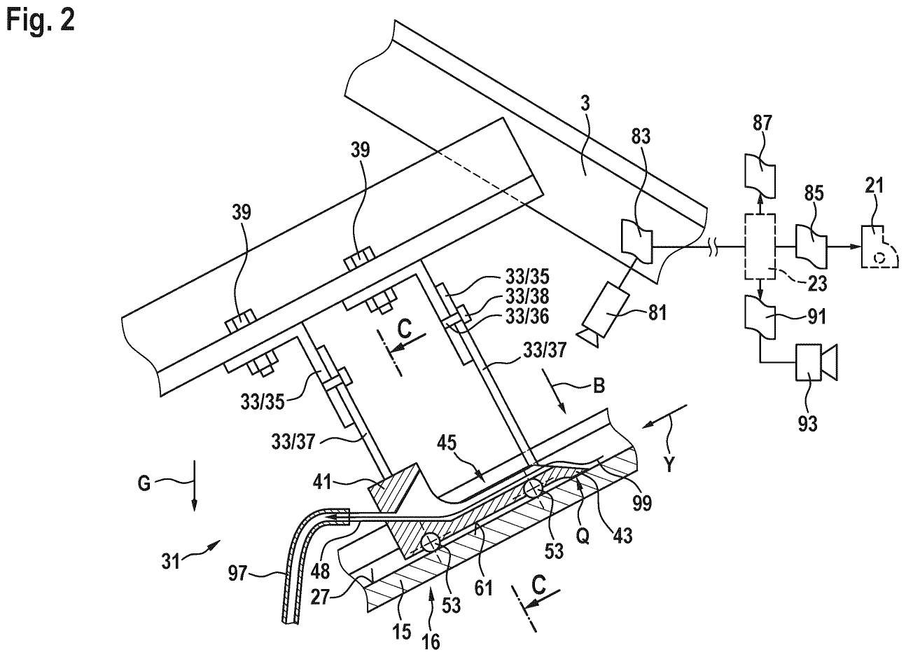

In order to achieve sufficient traction between the handrail 15 and the handrail drive wheel 25, the handrail 15 partially wraps around the handrail drive wheel 25. A device 31 for removing fluids 99 and dirt (see FIG. 2) is provided in each of the two portions 16, adjacent to the partial wrap-around, of the handrail 15. Providing two devices 31 for each handrail 15 means that the escalator 1 is intended to be operated in two opposite directions of movement Y, Z. If just one direction of movement Y is intended, the device 31 is arranged immediately upstream of the handrail drive wheel 25, accounting for the direction of movement Y of the handrail 15.

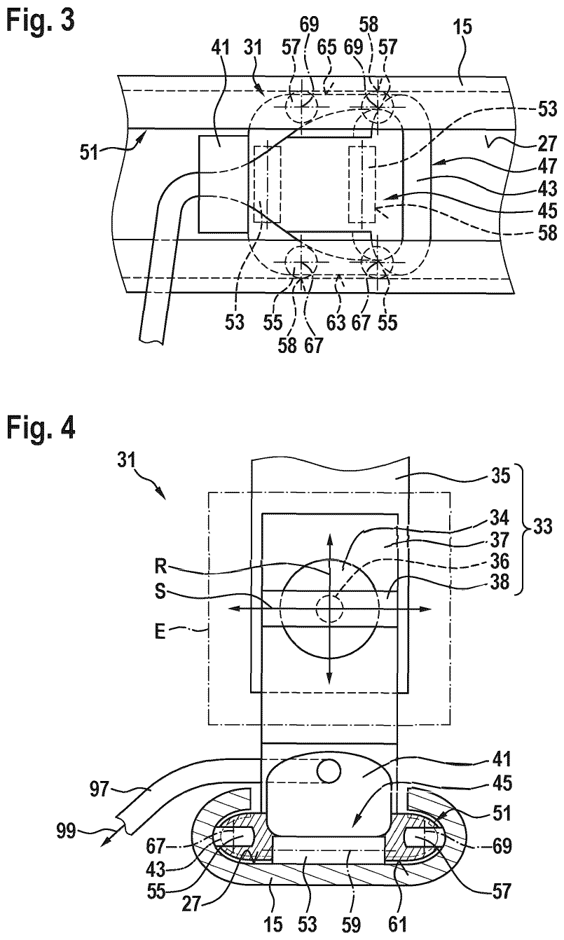

FIG. 2 is an enlarged, sectional side view of the region designated “A” in FIG. 1 with the device 31 according to the disclosure. FIG. 3 is a plan view, indicated by “B” in FIG. 2, of the device 31 and the handrail 15; and FIG. 4 is a section through the device 31 and the handrail 15, indicated by “C-C” in FIG. 2. These three figures are described together below.

The device 31 comprises a holder 33 and a scraper body 41 with a scraper lip 43. The scraper lip 43 has a wedge-shaped cross-section (see in particular FIG. 2). As can be seen from FIGS. 3 and 4, the contour 47 of the scraper lip 43 is adapted to an inner cross-section 51 of the moving handrail 15. Since the scraper lip 43 in FIG. 4 is located in front of the indicated sectional plane C-C, the scraper lip 43 is shown by means of a double-dot-dashed line.

As can be seen in particular from FIGS. 1 and 2, the scraper lip 43 of the scraper body 41 is in scraping touching contact with the same surface 27 of the handrail 15 as the motion-transmitting handrail drive wheel 25.

In the scraper body 41, a collecting channel 45 is formed which is directly adjacent to the scraper lip 43. The collecting channel 45 also opens into a connection piece 48 formed in the scraper body 41. The connection piece 48 is designed such that it can be connected to a drain line 97. Of course, the drain line 97 can also be non-detachably connected to the scraper body 41.

Furthermore, two first guide rollers 53 are rotatably mounted on or in the scraper body 41, wherein said rollers protrude from a bottom surface 61 of the scraper body 41. In addition, two second guide rollers 55 are rotatably mounted on or in the scraper body 41, which protrude from a left-hand side surface 63 of the scraper body 41. In the same way, two third guide rollers 57 are rotatably mounted on or in the scraper body 41, which protrude from a right-hand side surface 65 of the scraper body 41. As can be seen from FIG. 2 to 4, the axes of rotation 67, 69 of the second and third guide rollers 55, 57 are arranged parallel to each other and orthogonal to the axes of rotation 59 of the first guide rollers 53 in the scraper body 41. The guide rollers 53, 55, 57 thus guide the scraper body 41, with their rolling surfaces 58, at a defined distance in the inner cross-section 51 of the handrail 15.

The holder 33 has a first holder part 35, which is fixedly attached with screws 39 to a stationary component such as the supporting structure 3 shown in the present embodiment. As FIG. 2 shows, two holders 33 are provided for better guidance properties. Since the handrail 15 is guided only in certain places within the balustrade base 12, the handrail 15 can move, in the region of the device 31, in the lateral direction S and orthogonally thereto in the vertical direction R. In order to avoid excessive forces on the guide rollers 53, 55, 57, the holder 33 therefore has a second holder part 37 which is fixedly connected to the first holder part 35 in a plane E in a path-limited, floating manner and orthogonally to this plane E. The travel limitation in the plane E is made possible by a drilled hole 34 and a pin 36 with a retaining plate 38, wherein there is plenty of play between the drilled hole 34 and the pin 36. The scraper body 41 is attached to the second holder part 37.

The device 31 is provided at a location where the handrail 15 has a steep slope. In other words, the scraper body 41 of the device 31 is arranged in an inclined portion 16 of the handrail 15 with respect to a direction of gravity G such that, as a result of gravity G, at least the fluid 99 scraped from the handrail 15 by the scraper lip 43 passes from the scraper lip 43 into the collecting channel 45 formed in the scraper body 41.

In order to monitor the physical state of the scraper lip 43, the device 31 has a monitoring sensor 81 (only shown in FIG. 2). As the monitoring sensor 81, the most varied types of sensors, such as a camera, a TOF camera, a laser scanner, a LiDAR sensor, and the like, can be used, which can detect the current state of the contour 47 of the scraper lip 43.

In the present embodiment, the measurement data 83 from the monitoring sensor 81 are transmitted to the controller 23 of the escalator 1 or moving walkway. The measurement data 83 are processed in the controller 23 and are compared against condition criteria (not shown). If the detected state no longer corresponds to the specified state criteria, a travel stop command 85 can be output to the drive 21, and/or maintenance requests 87 can be output to a maintenance center (not shown), and/or warning messages 91 can be output to a communications unit 93, depending upon the detected state.

Although the disclosure has been described by illustrating specific embodiments, it is obvious that numerous further embodiment variants can be created with knowledge of the present disclosure, e.g., by the device 31 additionally having a warm air blower with which the still moist surface 27 of the handrail 15 can be dried after the passage of the scraper body 41.

1-15. (canceled)

16. A device configured to remove fluids and dirt from a moving handrail of an escalator or a moving walkway, wherein the device comprises:
a holder;
a scraper body comprising a scraper lip, wherein the scraper lip comprises a wedge-shaped cross-section; and
a collecting channel arranged in the scraper body adjacent to the scraper lip.

17. The device of claim 16, wherein the collecting channel opens into a drain line of the device.

18. The device of claim 16, wherein the collecting channel opens into a connecting piece formed in the scraper body, wherein the connecting piece is configured to be connected to a drain line.

19. The device of claim 16, further comprising at least one guide roller which is rotatably mounted on the scraper body.

20. The device of claim 17, further comprising at least one guide roller which is rotatably mounted on the scraper body.

21. The device of claim 18, further comprising at least one guide roller which is rotatably mounted on the scraper body.

22. The device of claim 19, wherein the at least one guide roller is arranged on the scraper body such that a rolling surface of the at least one guide roller partially protrudes from the scraper body.

23. The device of claim 22, wherein a first guide roller protrudes from a bottom surface of the scraper body, a second guide roller protrudes from a left-hand side surface of the scraper body, and a third guide roller protrudes from a right-hand side surface of the scraper body, and wherein axes of rotation of the second guide roller and the third guide roller are arranged parallel to one another and orthogonal to an axis of rotation of the first guide roller in the scraper body.

24. The device of claim 16, wherein the holder comprises a first holder part configured to fixedly attach to a stationary component of the escalator or the moving walkway, and wherein the holder comprises a second holder part which is fixedly connected to the first holder part in a plane, in a path-limited and floating manner and orthogonally to this plane, and wherein the scraper body is attached to the second holder part.

25. The device of claim 17, wherein the holder comprises a first holder part configured to fixedly attach to a stationary component of the escalator or the moving walkway, and wherein the holder comprises a second holder part which is fixedly connected to the first holder part in a plane, in a path-limited and floating manner and orthogonally to this plane, and wherein the scraper body is attached to the second holder part.

26. The device of claim 18, wherein the holder comprises a first holder part configured to fixedly attach to a stationary component of the escalator or the moving walkway, and wherein the holder comprises a second holder part which is fixedly connected to the first holder part in a plane, in a path-limited and floating manner and orthogonally to this plane, and wherein the scraper body is attached to the second holder part.

27. An escalator or a moving walkway comprising at least one peripherally arranged moving handrail with a C-shaped cross-section comprising:
a handrail drive comprising a handrail drive wheel arranged in a region of a return run and in contact with a surface of the at least one peripherally arranged moving handrail and configured to drive the at least one peripherally arranged moving handrail; and
at least one of the device of claim 16 arranged with its scraper lip opposite to an intended direction of movement of the at least one peripherally arranged moving handrail, in an inner cross-section of the at least one peripherally arranged moving handrail provided by the C-shaped cross-section, and directly in front of the handrail drive wheel.

28. The escalator or the moving walkway of claim 27, wherein a contour of the scraper lip is matched to the inner cross-section of the at least one peripherally arranged moving handrail.

29. The escalator or the moving walkway of claim 27, wherein one of the at least one device is arranged on each side of the handrail drive wheel with respect to two possible directions of movement of the at least one peripherally arranged moving handrail.

30. The escalator or the moving walkway of claim 27, wherein the scraper lip of the scraper body is in contact with the surface of the at least one peripherally arranged moving handrail.

31. The escalator or the moving walkway of claim 27, wherein, with respect to a direction of gravity, the scraper body of the at least one device is arranged in an inclined portion of the at least one peripherally arranged moving handrail such that, as a result of gravity, at least the fluids scraped from the at least one peripherally arranged moving handrail by the scraper lip passes from the scraper lip into the collecting channel.

32. The escalator or the moving walkway of claim 28, wherein, with respect to a direction of gravity, the scraper body of the at least one device is arranged in an inclined portion of the at least one peripherally arranged moving handrail such that, as a result of gravity, at least the fluids scraped from the at least one peripherally arranged moving handrail by the scraper lip passes from the scraper lip into the collecting channel.

33. The escalator or the moving walkway of claim 27, wherein the holder of the device is arranged in a stationary manner in a balustrade base of the escalator or the moving walkway.

34. The escalator or the moving walkway of claim 27, wherein the escalator or the moving walkway comprises a monitoring sensor directed towards the scraper lip configured to monitor a physical condition of the scraper lip.

35. The escalator or the moving walkway of claim 34, wherein measurement data from the monitoring sensor is transmitted to a controller of the escalator or the moving walkway, and wherein the measurement data is processed in the controller to output at least one of travel stop commands, maintenance requests or warning messages, based on the measurement data processed.
